(19) United States
(12) Patent Application Publication
(10) Pub. No.: US 2005/0132859 A1
(43) Pub. Date: Jun. 23, 2005

(54) Electromotive hole puncher

(75) Inventor: Simon Hunag, SanChung City (TW)

Correspondence Address: DENNISON, SCHULTZ, DOUGHERTY & MACDONALD, 1727 KING STREET, SUITE 105, ALEXANDRIA, VA, 22314, US

(73) Assignee: MICHILIN PROSPERITY CO., LTD.

(21) Appl. No.: 10/736,577

(22) Filed: Dec. 17, 2003

(51) Int. Cl. B26F 1/02

(52) U.S. Cl. 83/628; 83/687

(57) ABSTRACT

This invention discloses an electromotive hole puncher, comprising: a base; at least one actuatable driving device affixed to a predetermined position on the base, the actuatable driving devices each being selectively locked to a first position or a second position; a predetermined number of punch units being equivalent to the number of driving devices and affixed to the base at positions corresponding to the driving devices, wherein the corresponding actuatable driving devices and punch units are situated at different levels when the actuatable driving devices are each at the first position, and the corresponding actuatable driving devices and punch units are situated at the same level when the actuatable driving devices are each at the second position, whereby the punch unit is selectively driven by the driving device; and a transmission mechanism for transmitting a driving power to each of the driving devices. As such, the operator is able to adjust the distance between the punch positions in accordance with the required punch-hole specifications, so as to provide more flexibility of the hole puncher.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to an electromotive hole puncher, particularly to an electromotive hole puncher with an adjustable number of punches so as to meet various punch-hole specifications.

### BACKGROUND

The commercially available hole punchers are mostly manually driven double-hole or single-hole press punches, which are able to form punches at predetermined locations of a piece of paper inserted between a paper recess of a paper support upon an operator pressing a lever downwards to facilitate subsequently binding tasks.

Since hole punchers having fixed punch positions cannot be adapted to various punch-hole specifications, there have been developed numerous hole punchers with adjustable punch positions or adjustable distance between the punch positions in the market. For example, TW337245Y disclosed an adjusting mechanism for a hole puncher for adjusting the punch positions; TW521693Y disclosed an improved hole puncher capable of selectively shielding a punch die by means of a control plate.

Other electromotive hole punchers have also been developed to allow easy operation, such as those disclosed in TW176321Y and TW398398Y. Such electromotive hole punchers are provided with punch dies at fixed positions and/or a contact switch at the paper recess of the paper support, such that upon inserting a piece of paper to be punched into the recess provided on the hole puncher, the paper would activate the contact switch to turn on a motor for generating a power to drive rotation movements of fly wheels provided at opposing sides of transmission gears and reciprocal movements of sliding shafts on the fly wheels thereby activating punch dies to punch holes on the paper.

However, such electromotive hole punchers have not yet provided a simple mechanism for determining the number of punches in an easy operative manner so as to meet various punch-hole specifications.

Hence, it is an important topic in the industry to provide a hole puncher featuring with a simple mechanism for determining the number of punches in an easy operative manner.

### SUMMARY OF INVENTION

It is a primary objective this invention is to provide an electromotive hole puncher, capable of adjusting the distance between the punch positions in accordance with the required punch-hole specifications, so as to provide more flexibility of the hole puncher.

It is a further objective of this invention to provide an electromotive hole puncher, featuring with a simple mechanism for determining the number of punches in an easy operative manner so as to provide different punch positions and punch distance.

To achieve the above objectives and to resolve disadvantages of prior art, this invention discloses an electromotive hole puncher, comprising: a base; at least one actuatable driving device affixed to a predetermined position on the base, the actuatable driving devices each being selectively locked to a first position or a second position; a predetermined number of punch units being equivalent to the number of driving devices, and affixed to the base at positions corresponding to the driving devices, wherein the corresponding actuatable driving devices and punch units are situated at different levels when the actuatable driving devices are each at the first position, and the corresponding actuatable driving devices and punch units are situated at the same level when the actuatable driving devices are each at the second position, whereby the punch unit is selectively driven by the driving device; and a transmission mechanism, for transmitting a driving power to each of the driving devices.

According to one aspect of this invention, the punch units each comprise: a paper support, the paper support being formed with a paper recess at an end thereof; a punch die slidably provided to the paper support, the punch die being provided with a cutting blade at an end face thereof, a recovering spring engaging over the punch die; and an urging block affixed to another end face of the punch die.

According to one aspect of this invention, the actuatable driving devices each comprise: a gear driven by the transmission mechanism; a cam affixed to a rotating shaft of the gear and rotating synchronously with the gear; and an actuator affixed to the cam and subjecting the cam to be selectively locked to the first position or the second position, wherein the cam and the urging block of the corresponding punch unit are situated at different levels when the cam is at the first position, and the cam and the urging block of the corresponding punch unit are situated at the same level when the cam is at the second position.

According to one aspect of this invention, the punch dies each comprise: a reduced neck; a paper-retaining pin and a spring, inserted into the punch die through a tail end thereof; and a mounting peg, for retaining the paper-retaining pin and the spring in the punch die, such that the paper-retaining pin is able to displace reciprocally within the paper-retaining pin by means of compression and expansion of the spring.

According to one aspect of this invention, the electromotive hole puncher further comprises: a powering device for driving the transmission mechanism.

According to one aspect of this invention, the powering device is a motor.

According to one aspect of this invention, the transmission mechanism includes a reducing mechanism constructed of a plurality of meshing gears.

According to one aspect of this invention, the gear is an eccentric wheel.

According to one aspect of this invention, the electromotive hole puncher further comprises: a stationary driving device affixed to a predetermined position of the base, wherein the stationary driving device and a corresponding punch unit are situated at the same level.

According to one aspect of this invention, the stationary driving device comprises: a gear driven by the transmission mechanism; and a cam affixed to a rotating shaft of the gear and rotating synchronously with the gear, the cam and the corresponding punch unit are situated at the same level.

According to one aspect of this invention, the gear is an eccentric wheel.

### BRIEF DESCRIPTION OF THE DRAWINGS

These and other modifications and advantages will become even more apparent from the following detained description of a preferred embodiment of the invention and from the drawings in which:

FIG. 1 is a perspective view of a punching mechanism for an electromotive hole puncher according to this invention;

FIG. 2 is a perspective view of the electromotive hole puncher in FIG. 1 upon removal of part of the housing;

FIG. 3 is an exploded perspective of the electromotive hole puncher in FIG. 1;

FIG. 4 is an enlarged perspective view of a stationary driving device and its corresponding punch unit according to this invention;

FIG. 5 is an enlarged perspective view of an actuatable driving device and its corresponding punch unit according to this invention; and

FIG. 6 is an exploded perspective view of a chip ejecting device implemented in the punch unit according to this invention.

### DETAILED DESCRIPTION OF THE INVENTION (PREFERRED EMBODIMENTS)

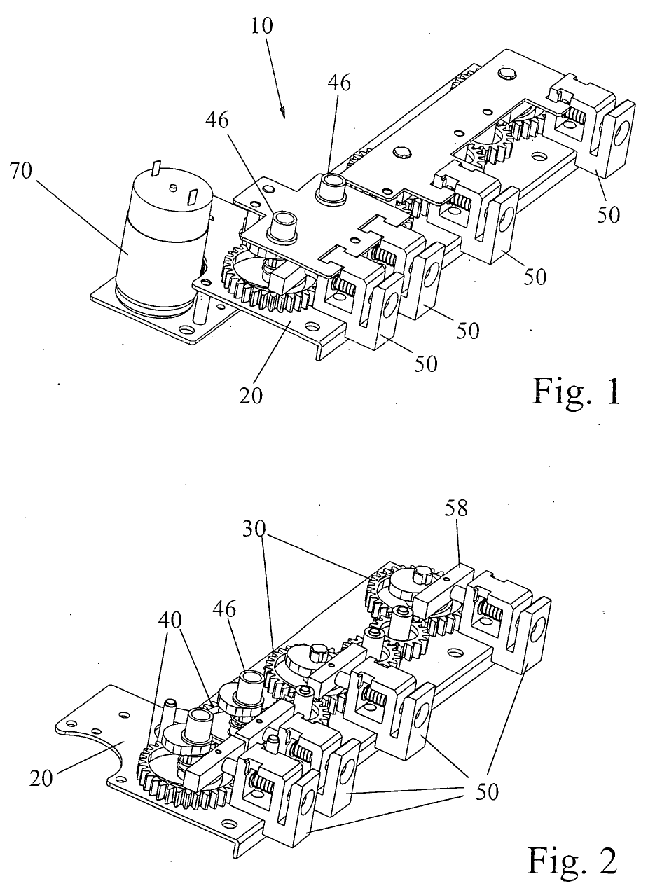

With reference to FIGS. 1 to 3, FIGS. 1 and 3 illustrate FIG. 1 is a perspective view and an exploded view of a punching mechanism for an electromotive hole puncher according to this invention, respectively; FIG. 2 illustrates a perspective view of the electromotive hole puncher in FIG. 1 upon removal of part of the housing.

As shown in FIG. 1, the electromotive hole puncher according to this invention includes a punching mechanism 10 Because the punching mechanism 10 is the primary mechanism based on which this invention offers the electromotive-punching effect, the punching mechanism 10 will be referred to as a hole puncher throughout this invention.

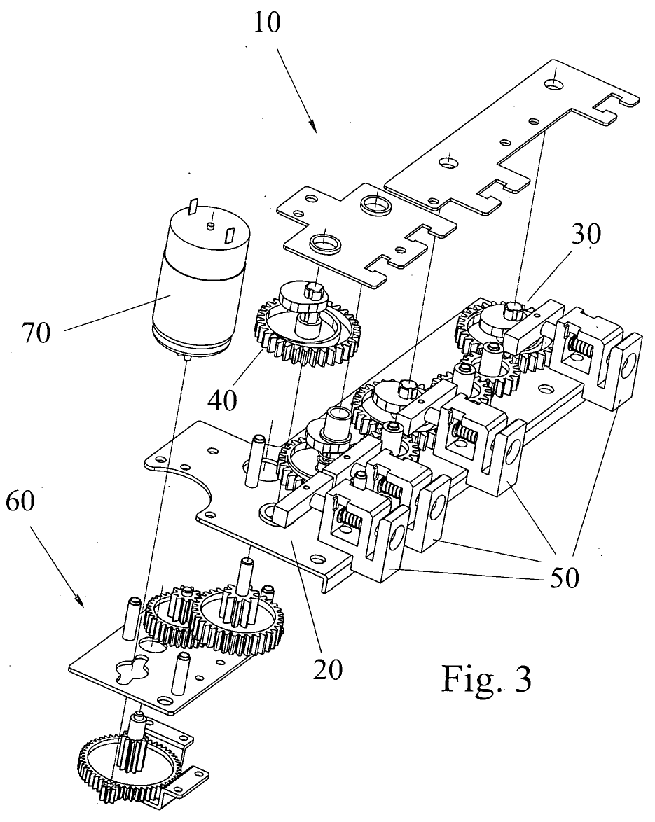

As shown in FIGS. 2 and 3, the hole puncher (punching mechanism) 10 comprises: a base 20; at least one driving device 30, 40, affixed to a predetermined position of the base 20, wherein at least one of the driving devices is an actuatable driving device 40. The embodiment illustrated in this invention includes four driving devices 30, 40, that is, two stationary driving devices 30 and two actuatable driving devices 40. The hole puncher 10 also includes a predetermined number of punch units 50 being equivalent to the number of driving devices 30, 40, and affixed to the base 20 at positions corresponding to the driving devices 30, 40, to be selectively driven by the driving devices 30, 40; a transmission mechanism 60 for transmitting a driving power to each of the driving device 33, 40. With reference to FIG. 3, the transmission mechanism 60 may be driven by a motor 70 or any other suitable powering devices, and includes a reducing mechanism constructed of a plurality of meshing gears that are operatively meshed with the driving devices 30, 40.

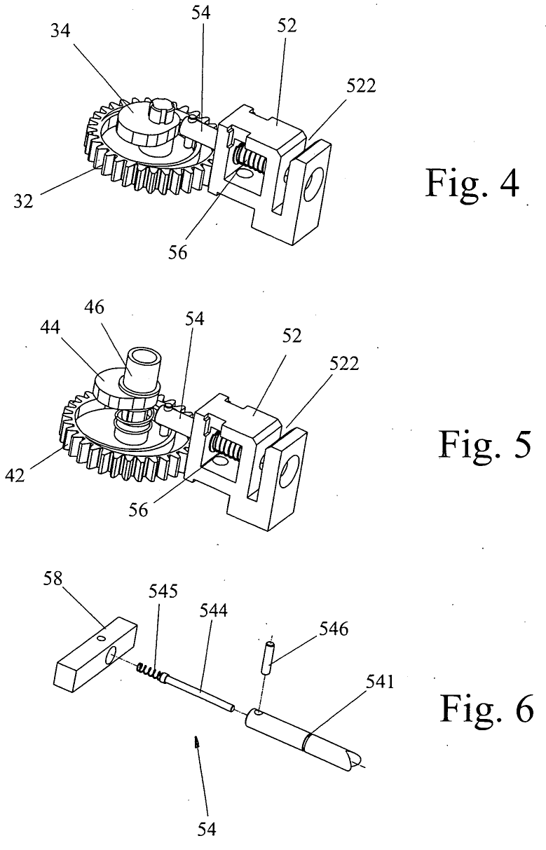

FIG. 4 is an enlarged perspective view of a stationary driving device 30 and its corresponding punch unit 50. As shown in FIGS. 4 and 6, the punch unit 50 includes: a paper support 52, the paper support 52 being formed with a paper recess 522 at an end thereof; a punch die 54 slidably provided to the paper support 52, the punch die 54 being provided with a cutting blade 542 at an end face thereof; a recovering spring 56 engaging over the punch die 54; and an urging block 58 affixed to another end face of the punch die 54.

As illustrated in FIG. 6, according to this invention, the punch die 54 may further be provided therein with a paper-retaining pin 544 to assist in retaining a piece of paper inserted in the paper recess 522 during punching. As shown in FIG. 6, the punch dies 54 each comprise: a reduced neck 541; a paper-retaining pin 544 and a spring 545, inserted into the punch die 54 through a tail end thereof, the paper-retaining pin 544 and the spring 545 being retained in the punch die 54 by a mounting peg 546, such that the paper-retaining pin 544 is able to displace reciprocally within the punch die 54 by means of compression and expansion of the spring 545, for preventing jamming of the punch die 54 by ejecting paper chips accumulated in the punch die 54.

As shown in FIG. 5, the stationary driving device 30 includes: a gear 32 driven by the transmission mechanism 60; a cam 34 affixed to a rotating shaft of the gear 32 and rotating synchronously with the gear 32, wherein the cam 34 and the urging block 58 of a corresponding punch unit 54 are situated at the same level. As such, when the transmission mechanism 60 drives rotation of the gear 32, the gear 32 will subsequently drive rotation of the cam 34 thereby pressing the urging block 58 and corresponding punch die 54 situated at the same level, subjecting the cutting blade 542 to punch a hole on a piece of paper inserted in the paper recess 522. After the gear 32 is driven to rotate for a complete revolution, the cam 34 adapts to rotate for a complete revolution and returns to the original state of not contacting the urging block 58, while the recovering spring 56 also recovers the urging block 58 and punch die 54 to a non-compressed state.

FIG. 5 is an enlarged perspective view of an actuatable driving device 40 and its corresponding punch unit 50.

The punch die 50 illustrated in FIG. 5 consists of the same structure as that illustrated in FIG. 4 and is not repeated hereafter.

With reference to FIG. 5, the actuatable driving device 40 includes a gear 42 driven by the transmission mechanism 60; a cam 44 affixed to a rotating shaft of the gear 42 and rotating synchronously with the gear 42; and an actuator 46 affixed to the cam 44. The actuator 46 may be of a conventional construction consisting of alternatively-arranged deep and shallow grooves, projections and a recovering spring, such that each pushing action will selectively lock the cam 44 to a first position or a second position. The details of the actuator 46 are not repeated herein.

According to this invention, the cam 44 and the urging block 58 of the corresponding punch unit 50 are situated at different levels when the cam 44 is at the first position, where the cam 44 may either be situated at a lower or a higher level, whereas the cam 44 and the urging block 58 of the corresponding punch unit 50 are situated at the same level when the cam is at the second position.

As such, when the actuator 46 locks the cam 44 to the first position, even if the transmission mechanism 60 drives rotation of the gear 42, the cam 44 is incapable of causing the cam 34 to press the urging block 58 and corresponding punch die 54 because they are not situated at the same level.

On the other hand, if the actuator 46 locks the cam 44 to the second position, when the transmission mechanism 60 drives rotation of the gear 42, the gear 42 is able to drive rotation of the cam 44 thereby pressing the urging block 58 and corresponding punch die 54 situated at the same level, subjecting the cutting blade 542 to punch a hole on a piece of paper inserted in the paper recess 522.

Like the stationary driving device 30 previously described, after the gear 42 is driven to rotate for a complete revolution, the cam 44 adapts to rotate for a complete revolution and returns to the original state of not contacting the urging block 58, while the recovering spring 56 also recovers the urging block 58 and punch die 54 to a non-compressed state.

According to an embodiment of this invention, the gears 32, 42 of the driving devices 30, 40 may each be an eccentric wheel, such that the cams 34, 44 are able to effectively press the urging blocks 48 situated at the same level when the transmission mechanism 60 drives rotation of the gears 32, 42, thereby pushing the cutting blade 542 formed at the end face of the punch dies 54 towards the paper recess 522.

According to this invention, operators are able to control whether each of the independent actuators 46 are to be pressed by an easy pushing operation so as to selectively lock the cams 44 of the actuatable driving devices 40 to a first or a second position, being capable or incapable of respective actuating the punch dies 54, respectively. Hence, this invention allows the operators to adjust the distance between the punch positions in accordance with the required punch-hole specifications, so as to provide more flexibility of the hole puncher.

To enhance the flexibility of the electromotive hole puncher of this invention, all driving devices may be actuatable driving devices. Alternatively, one may also design the hole puncher such that the driving device located at a terminal end of the hole puncher is a stationary driving device for positioning purpose, while the remaining driving devices are actuatable driving devices. A contact switch may also be provided in one of the recesses of the paper support, such that upon inserting a piece of paper to be punched into the paper recess provided on the hole puncher, the paper would activate the contact switch to turn on the electromotive hole puncher. Such modifications are those that may be easily conceived by persons ordinarily skilled in the art based on the disclosures of this invention.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

### Nomenclature Listing

10 hole puncher/punching mechanism
20 base
30 stationary driving device
32 gear
34 cam
40 actuatable driving device
42 gear
44 cam
46 actuator
50 punch unit
52 paper support
54 punch die
56 recovering spring
58 urging block
60 transmission mechanism
70 motor
522 paper recess
541 neck
542 cutting blade
544 paper-retaining pin
545 spring
546 mounting peg

1. An electromotive hole puncher, comprising:
a base;
at least one actuatable driving device affixed to a predetermined position on the base, the actuatable driving devices each being selectively locked to a first position or a second position;
a predetermined number of punch units being equivalent to the number of driving devices, and affixed to the base at positions corresponding to the driving devices, wherein the corresponding actuatable driving devices and punch units are situated at different levels when the actuatable driving devices are each at the first position, and the corresponding actuatable driving devices and punch units are situated at the same level when the actuatable driving devices are each at the second position, whereby the punch unit is selectively driven by the driving device; and
a transmission mechanism for transmitting a driving power to each of the driving devices.

2. The electromotive hole puncher according to claim 1, wherein the punch units each comprise:
a paper support, the paper support being formed with a paper recess at an end thereof;
a punch die slidably provided to the paper support, the punch die being provided with a cutting blade at an end face thereof;
a recovering spring engaging over the punch die; and
an urging block affixed to another end face of the punch die.

3. The electromotive hole puncher according to claim 2, wherein the actuatable driving devices each comprise:
a gear driven by the transmission mechanism;
a cam affixed to a rotating shaft of the gear and rotating synchronously with the gear; and
an actuator affixed to the cam and subjecting the cam to be selectively locked to the first position or the second position, wherein the cam and the urging block of the corresponding punch unit are situated at different levels when the cam is at the first position, and the cam and the urging block of the corresponding punch unit are situated at the same level when the cam is at the second position.

4. The electromotive hole puncher according to claim 2, the punch dies each comprise:
a reduced neck;
a paper-retaining pin and a spring, inserted into the punch die through a tail end thereof; and
a mounting peg, for retaining the paper-retaining pin and the spring in the punch die, such that the urging pin is able to displace reciprocally within the paper-retaining pin by means of compression and expansion of the spring.

5. The electromotive hole puncher according to claim 1, further comprising:
a powering device for driving the transmission mechanism.

6. The electromotive hole puncher according to claim 5, wherein the powering device is a motor.

7. The electromotive hole puncher according to claim 1, wherein the transmission mechanism includes a reducing mechanism constructed of a plurality of meshing gears.

8. The electromotive hole puncher according to claim 3, wherein the gear is an eccentric wheel.

9. The electromotive hole puncher according to claim 1, further comprising:
a stationary driving device affixed to a predetermined position of the base, wherein the stationary driving device and a corresponding punch unit are situated at the same level.

10. The electromotive hole puncher according to claim 9, wherein the stationary driving device comprises:
a gear driven by the transmission mechanism; and
a cam affixed to a rotating shaft of the gear and rotating synchronously with the gear, the cam and the corresponding punch unit are situated at the same level.

12. The electromotive hole puncher according to claim 10, wherein the gear is an eccentric wheel.
